(19) United States
(12) Patent Application Publication
(10) Pub. No.: US 2026/0236306 A1
(43) Pub. Date: Aug. 13, 2026

(54) MODEL HUB ORCHESTRATION

(71) Applicant: INTERNATIONAL BUSINESS MACHINES CORPORATION, Armonk, NY (US)

(72) Inventors: Guangya Liu, Cary, NC (US); Peng Li, Xian (CN); Feng Li, Xian (CN); Jin Chi He, Xian (CN)

(21) Appl. No.: 19/049,201

(22) Filed: Feb. 10, 2025

(51) Int. Cl. G06F 9/50; G06F 9/48

(52) U.S. Cl. CPC G06F 9/5027; G06F 9/4881; G06F 9/5072; G06F 2209/501

(57) ABSTRACT

Model hub orchestration includes identifying, by a model scheduler of a model hub orchestrator in response to a request from a client device, a plurality of processing blocks of a machine learning model. The model scheduler assigns each processing block an index indicating a position of the processing block within a sequential arrangement of the plurality of processing blocks of the machine learning model. The model scheduler selects one or more model hubs communicatively coupled with the model hub orchestrator to store different ones of the plurality of processing blocks. The model scheduler transfers the plurality of processing blocks from the client device to the one or more model hubs as selected.

### BACKGROUND

This disclosure relates to machine learning and, more particularly, to computational tools for storing, accessing, and sharing machine learning models.

Machine learning is a major subfield of artificial intelligence. Machine learning models are built using statistical and mathematical optimization algorithms that are capable of learning to perform a wide range of tasks based on various types of data, including both labeled data for supervised learning and unlabeled data for unsupervised learning. As the sophistication and applications of machine learning grows, various collaborative platforms have been created for sharing machine learning models and datasets used in training the models. The collaborative platforms may enable users to access open-source machine learning models and often provide libraries (e.g., transformer library) that the users may utilize to train the models to perform natural language processing (NLP), image recognition, text and audio generation, and various other machine learning tasks.

### SUMMARY

In one or more embodiments, a method of model hub orchestration includes identifying, by a model scheduler of a model hub orchestrator in response to a request from a client device, a plurality of processing blocks of a machine learning model. The model scheduler assigns each processing block an index indicating a position of the processing block within a sequential arrangement of the plurality of processing blocks of the machine learning model. The model scheduler selects one or more model hubs communicatively coupled with the model hub orchestrator to store different ones of the plurality of processing blocks. The model scheduler transfers the plurality of processing blocks from the client device to the one or more model hubs as selected.

In one or more embodiments, a system includes one or more processors configured to initiate executable operations as described within this disclosure.

In one or more embodiments, a computer program product includes one or more computer-readable storage media and program instructions collectively stored on the one or more computer-readable storage media. The program instructions are executable by a processor to cause the processor to initiate operations as described within this disclosure.

This Summary section is provided merely to introduce certain concepts and not to identify any key or essential features of the claimed subject matter. Many other features and embodiments of the invention will be apparent from the accompanying drawings and from the following detailed description.

### BRIEF DESCRIPTION OF THE DRAWINGS

The accompanying drawings show one or more embodiments; however, the accompanying drawings should not be taken to limit the invention to only the embodiments shown. Various aspects and advantages will become apparent upon review of the following detailed description and upon reference to the drawings.

FIG. 1 illustrates an example of a computing environment that is capable of implementing a model hub orchestrator (MHO) framework.

FIG. 2 illustrates an example architecture of the MHO framework.

FIG. 3 illustrates internal communications among components of the MHO framework and external communications between multiple devices and the MHO framework of FIG. 2.

FIG. 4 illustrates an example method of operation of the MHO framework of FIG. 2.

FIG. 5 is a signal diagram illustrating certain operations performed by the MHO framework of FIG. 2 in pushing a processing block to one or more model hubs.

FIGS. 6A and 6B illustrate certain operations performed by the MHO framework of FIG. 2 in pushing multiple processing blocks to one model hub in accordance with an example user-specified policy.

FIGS. 7A and 7B illustrate certain operations performed by the MHO framework of FIG. 2 in pushing multiple processing blocks to multiple model hubs in accordance with another example user-specified policy.

FIG. 8 illustrates an example method of operation of the MHO framework of FIG. 2.

FIG. 9 is a signal diagram illustrating certain operations performed by the MHO framework of FIG. 2 in pulling a processing block from one or more model hubs.

FIGS. 10A and 10B illustrate certain operations performed by the MHO framework of FIG. 2 in pushing multiple processing blocks of a machine learning model to multiple model hubs and subsequently pulling the processing blocks from the model hubs.

### DETAILED DESCRIPTION

While this disclosure concludes with claims defining novel features, it is believed that the various features described herein will be better understood from consideration of the description in conjunction with the drawings. The process(es), machine(s), manufacture(s) and any variations thereof described within this disclosure are provided for purposes of illustration. Any specific structural and functional details described are not to be interpreted as limiting, but merely as a basis for the claims and as a representative basis for teaching one skilled in the art to variously employ the features described in virtually any appropriately detailed structure. Further, the terms and phrases used within this disclosure are not intended to be limiting, but rather to provide an understandable description of the features described.

This disclosure relates to machine learning and, more particularly, to computational tools for storing, accessing, and sharing machine learning models. The computational tools may be provided by a machine learning sharing platform, which may implement one or more model hubs. A model hub is a repository of machine learning models, which may be pretrained for performing a wide range of applications. Users may upload and share machine learning models on the model hub. Notwithstanding the benefits of a model hub, conventional techniques typically require that a machine learning model be pushed to, or pulled from, the model hub as a single, monolithic entity, which precludes fine-grained management of the model on multiple, distributed model hubs.

In accordance with the inventive arrangements described herein, methods, systems, and computer program products are provided that are capable of orchestrating a machine learning model into split or sharded into multiple, discrete processing blocks and transferring the processing blocks between a client and one or more distributed model hubs based on a user-specified policy.

Thus, in one aspect, the inventive arrangements segment a machine learning model into discrete processing blocks. A deep neural network, for example, may be segmented by the inventive arrangements into processing blocks that each include one or more transformation layers having linearly weighted variables that feed into nonlinear activation functions. A decoder-only transformer, for example, may be segmented by the inventive arrangements into separate self-attention and feed-forward neural network processing blocks along with other processing blocks of the model.

A technical advantage of segmenting the machine learning model is that the model may be treated as a collection of distinct processing blocks rather than a monolithic entity. With this aspect, the inventive arrangements are capable of providing distributed model hub management in which the discrete processing blocks are pushed to, and pulled from, model hubs in accordance with one or more user-specified policies. Pushing or pulling the machine learning model as a single entity, as is typical with conventional techniques, precludes fine-grained management of the model using multiple model hubs. Treating the machine learning model as a collection of discrete processing blocks enables fine-grained management of the model on multiple, distributed model hubs. The multiple model hubs may be provided by a single platform or by different platforms.

In one aspect, the inventive arrangements enable a user to specify whether discrete processing blocks of a machine learning model are to be persisted in a single model hub or multiple model hubs. In another aspect, the inventive arrangements enable a user to specify that one or more discrete processing blocks are to be replicated and persisted in separate model hubs to safeguard against a loss of access to the model stemming from a failure of one of the model hubs.

Further aspects of the inventive arrangements are described below with reference to the figures. For purposes of simplicity and clarity of illustration, elements shown in the figures have not necessarily been drawn to scale. For example, the dimensions of some of the elements may be exaggerated relative to other elements for clarity. Further, where considered appropriate, reference numbers are repeated among the figures to indicate corresponding, analogous, or like features.

Various aspects of the inventive arrangement are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

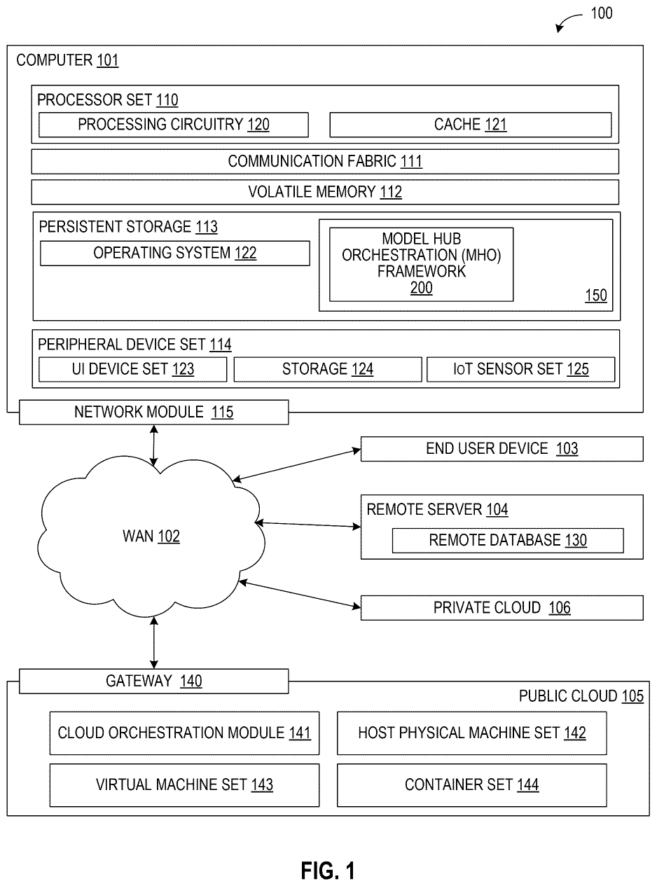

Referring to FIG. 1, computing environment 100 contains an example of an environment for the execution of at least some of the computer code illustrated at block 150 that is involved in performing the inventive methods disclosed herein. The inventive methods performed with the computer code of block 150 can include implementing model hub orchestration (MHO) framework 200.

MHO framework 200 is capable of managing multiple distributed model hubs, whether provided by the same or different model sharing platforms. In certain embodiments, MHO framework 200 collects model hub metrics for each of the model hubs. The metrics may specify the available storage space of a hub and/or the available bandwidth for transferring machine learning models between the hub and clients. MHO framework 200, in certain embodiments, uses the metrics to determine which of one or more model hubs to push one or more processing blocks of a machine learning models to in response to a client request. The client request may include one or more user-designated policies. MHO framework 200 selects the one or more model hubs that are most likely to optimize deployment of the processing blocks based on the persisted hub metrics and in accordance with the user-designated policies. Likewise, in pulling processing blocks of a machine learning model from one or more model hubs, MHO framework 200 selects the one or more hubs most likely to optimize retrieval in accordance with one or more user-specified policies.

In addition to block 150, computing environment 100 includes, for example, computer 101, wide area network (WAN) 102, end user device (EUD) 103, remote server 104, public cloud 105, and private cloud 106. In this embodiment, computer 101 includes processor set 110 (including processing circuitry 120 and cache 121), communication fabric 111, volatile memory 112, persistent storage 113 (including operating system 122 and block 150, as identified above), peripheral device set 114 (including user interface (UI) device set 123, storage 124, and Internet of Things (IoT) sensor set 125), and network module 115. Remote server 104 includes remote database 130. Public cloud 105 includes gateway 140, cloud orchestration module 141, host physical machine set 142, virtual machine set 143, and container set 144.

Computer 101 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 130. As is well understood in the art of computer technology, and depending upon the technology, performance of a computer-implemented method may be distributed among multiple computers and/or between multiple locations. On the other hand, in this presentation of computing environment 100, detailed discussion is focused on a single computer, specifically computer 101, to keep the presentation as simple as possible. Computer 101 may be located in a cloud, even though it is not shown in a cloud in FIG. 1. On the other hand, computer 101 is not required to be in a cloud except to any extent as may be affirmatively indicated.

Processor set 110 includes one, or more, computer processors of any type now known or to be developed in the future. Processing circuitry 120 may be distributed over multiple packages, for example, multiple, coordinated integrated circuit chips. Processing circuitry 120 may implement multiple processor threads and/or multiple processor cores. Cache 121 is memory that is located in the processor chip package(s) and is typically used for data or code that should be available for rapid access by the threads or cores running on processor set 110. Cache memories are typically organized into multiple levels depending upon relative proximity to the processing circuitry. Alternatively, some, or all, of the cache for the processor set may be located “off chip.” In some computing environments, processor set 110 may be designed for working with qubits and performing quantum computing.

Computer readable program instructions are typically loaded onto computer 101 to cause a series of operational steps to be performed by processor set 110 of computer 101 and thereby effect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as cache 121 and the other storage media discussed below. The program instructions, and associated data, are accessed by processor set 110 to control and direct performance of the inventive methods. In computing environment 100, at least some of the instructions for performing the inventive methods may be stored in block 150 in persistent storage 113.

Communication fabric 111 is the signal conduction paths that allow the various components of computer 101 to communicate with each other. Typically, this fabric is made of switches and electrically conductive paths, such as the switches and electrically conductive paths that make up buses, bridges, physical input/output ports and the like. Other types of signal communication paths may be used, such as fiber optic communication paths and/or wireless communication paths.

Volatile memory 112 is any type of volatile memory now known or to be developed in the future. Examples include dynamic type random access memory (RAM) or static type RAM. Typically, volatile memory is characterized by random access, but this is not required unless affirmatively indicated. In computer 101, the volatile memory 112 is located in a single package and is internal to computer 101, but, alternatively or additionally, the volatile memory may be distributed over multiple packages and/or located externally with respect to computer 101.

Persistent storage 113 is any form of non-volatile storage for computers that is now known or to be developed in the future. The non-volatility of this storage means that the stored data is maintained regardless of whether power is being supplied to computer 101 and/or directly to persistent storage 113. Persistent storage 113 may be a read only memory (ROM), but typically at least a portion of the persistent storage allows writing of data, deletion of data and re-writing of data. Some familiar forms of persistent storage include magnetic disks and solid-state storage devices. Operating system 122 may take several forms, such as various known proprietary operating systems or open-source Portable Operating System Interface type operating systems that employ a kernel. The code included in block 150 typically includes at least some of the computer code involved in performing the inventive methods.

Peripheral device set 114 includes the set of peripheral devices of computer 101. Data communication connections between the peripheral devices and the other components of computer 101 may be implemented in various ways, such as Bluetooth connections, Near-Field Communication (NFC) connections, connections made by cables (such as universal serial bus (USB) type cables), insertion type connections (e.g., secure digital (SD) card), connections made though local area communication networks and even connections made through wide area networks such as the internet. In various embodiments, UI device set 123 may include components such as a display screen, speaker, microphone, wearable devices (such as goggles and smart watches), keyboard, mouse, printer, touchpad, game controllers, and haptic devices. Storage 124 is external storage, such as an external hard drive, or insertable storage, such as an SD card. Storage 124 may be persistent and/or volatile. In some embodiments, storage 124 may take the form of a quantum computing storage device for storing data in the form of qubits. In embodiments where computer 101 is required to have a large amount of storage (e.g., where computer 101 locally stores and manages a large database) then this storage may be provided by peripheral storage devices designed for storing very large amounts of data, such as a storage area network (SAN) that is shared by multiple, geographically distributed computers. IoT sensor set 125 is made up of sensors that can be used in Internet of Things applications. For example, one sensor may be a thermometer, and another sensor may be a motion detector.

Network module 115 is the collection of computer software, hardware, and firmware that allows computer 101 to communicate with other computers through WAN 102. Network module 115 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 115 are performed on the same physical hardware device. In other embodiments (e.g., embodiments that utilize software-defined networking (SDN)), the control functions and the forwarding functions of network module 115 are performed on physically separate devices, such that the control functions manage several different network hardware devices. Computer readable program instructions for performing the inventive methods can typically be downloaded to computer 101 from an external computer or external storage device through a network adapter card or network interface included in network module 115.

WAN 102 is any wide area network (e.g., the internet) capable of communicating computer data over non-local distances by any technology for communicating computer data, now known or to be developed in the future. In some embodiments, the WAN may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

EUD 103 is any computer system that is used and controlled by an end user (e.g., a customer of an enterprise that operates computer 101), and may take any of the forms discussed above in connection with computer 101. EUD 103 typically receives helpful and useful data from the operations of computer 101. For example, in a hypothetical case where computer 101 is designed to provide a recommendation to an end user, this recommendation would typically be communicated from network module 115 of computer 101 through WAN 102 to EUD 103. In this way, EUD 103 can display, or otherwise present, the recommendation to an end user. In some embodiments, EUD 103 may be a client device, such as thin client, heavy client, mainframe computer, desktop computer and so on.

Remote server 104 is any computer system that serves at least some data and/or functionality to computer 101. Remote server 104 may be controlled and used by the same entity that operates computer 101. Remote server 104 represents the machine(s) that collect and store helpful and useful data for use by other computers, such as computer 101. For example, in a hypothetical case where computer 101 is designed and programmed to provide a recommendation based on historical data, then this historical data may be provided to computer 101 from remote database 130 of remote server 104.

Public cloud 105 is any computer system available for use by multiple entities that provides on-demand availability of computer system resources and/or other computer capabilities, especially data storage (cloud storage) and computing power, without direct active management by the user. Cloud computing typically leverages sharing resources to achieve coherence and economies of scale. The direct and active management of the computing resources of public cloud 105 is performed by the computer hardware and/or software of cloud orchestration module 141. The computing resources provided by public cloud 105 are typically implemented by virtual computing environments that run on various computers making up the computers of host physical machine set 142, which is the universe of physical computers in and/or available to public cloud 105. The virtual computing environments (VCEs) typically take the form of virtual machines from virtual machine set 143 and/or containers from container set 144. It is understood that these VCEs may be stored as images and may be transferred among and between the various physical machine hosts, either as images or after instantiation of the VCE. Cloud orchestration module 141 manages the transfer and storage of images, deploys new instantiations of VCEs and manages active instantiations of VCE deployments. Gateway 140 is the collection of computer software, hardware, and firmware that allows public cloud 105 to communicate through WAN 102.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

Private cloud 106 is similar to public cloud 105, except that the computing resources are only available for use by a single enterprise. While private cloud 106 is depicted as being in communication with WAN 102, in other embodiments a private cloud may be disconnected from the internet entirely and only accessible through a local/private network. A hybrid cloud is a composition of multiple clouds of different types (e.g., private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 105 and private cloud 106 are both part of a larger hybrid cloud.

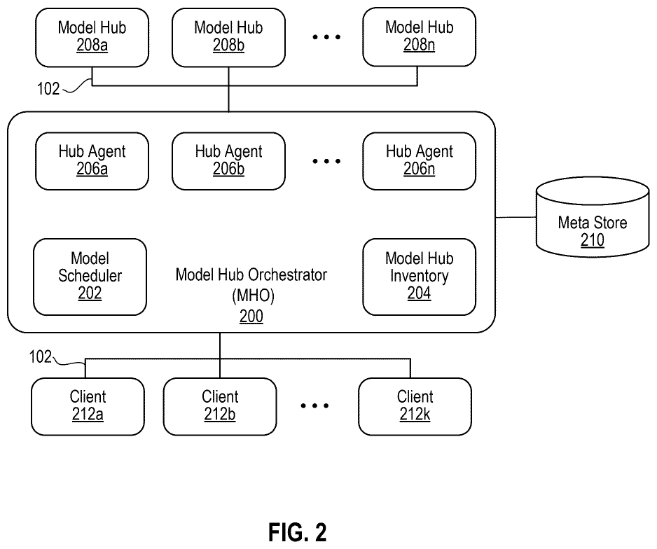

FIG. 2 illustrates an example architecture of MHO framework 200. In the example architecture of FIG. 2, MHO framework 200 illustratively includes model scheduler 202, model hub inventory 204, and hub agents 206a and 206b through 206n (where n is a positive integer). Model scheduler 202, model hub inventory 204, and hub agents 206a-206n, in certain embodiments, may be implemented with software executable on the hardware of computer 101 operating in computing environment 100. Implemented with the hardware of computer 101, MHO framework 200 communicatively couples through network module 115 to WAN (e.g., Internet) 102, and via WAN 102, to model hubs 208a and 208b through 208n. Hub agents 206a-206n uniquely correspond to, and collect metrics from, model hubs 208a-208n, respectively. Accordingly, each model hub is handled by its own hub agent of MHO framework 200. One or more model hubs 208a-208n may be implemented in end user devices, such as end user device 103, in one or more servers, such as remote server 104, and/or in public cloud 105 devices. Regardless of the particular implementation, each of the model hubs 208a-208n may connect via WAN 102 with MHO framework 200.

MHO framework 200 also communicatively couples with model metadata store (meta store) 210. Illustratively, meta store 210 is a database stored in storage 124 or other peripheral data device 114 of computer 101. In other embodiments, meta store 210 may be stored in persistent storage 113 of computer 101. Additionally, MHO framework 200 communicatively couples via WAN 102 with clients 212a and 212b through 212k (where k is a positive integer).

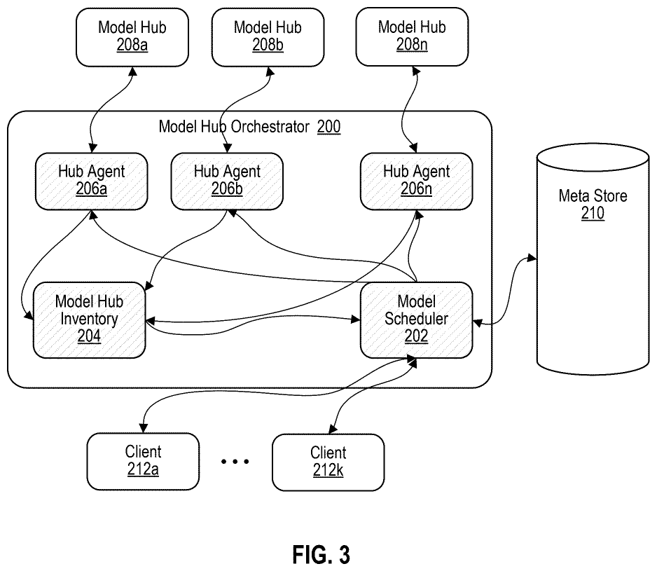

Referring additionally to FIG. 3, communications between model scheduler 202, model hub inventory 204, hub agents 206a-206n of MHO framework 200, model hubs 208a-208n, and clients 212a-212 are illustrated. Hub agents 206a-206n collect model hub metrics from model hubs 208a-208n and store the metrics in model hub inventory 204 for use by model scheduler 202. As described in greater detail below, model scheduler 202 determines which model hubs 208a-208n to push processing blocks of a machine learning model in response to a request by one of clients 212a-212k. Model hubs 208a-208n each comprise one or more computing systems configured to store and deploy one or more processing blocks of a machine learning model. Each model hub may be a platform that, although implemented by multiple interconnected computing systems, may be available as an atomic unit. Model scheduler 202, in certain embodiments, identifies the distinct processing blocks of the machine learning model based on files stored by a client. For example, a client may store a machine learning model in which distinct processing blocks are stored as individual layers in a local file system. The file system, for example, may have a format such as /path/to/model1/layer1, /path/to/model1/layer2, . . . , /path/to/model1/layern. The file system thus provides a mechanism for segmenting or sharding of the machine learning model into multiple processing blocks, and model scheduler 202 may read the local files to get each of the multiple processing blocks from the respective files of the client's local file system.

Each of the processing blocks is indexed by model scheduler 202, each index indicating a position of the processing block within a sequential arrangement of processing blocks of the machine learning model. The index of each processing block may be stored in meta store 210 along with metadata indicating the model hub in which a processing block is stored. The metadata is used by model scheduler 202 to pull processing blocks in response to a request by one of clients 212a-212k. Model scheduler 202 assembles the machine learning model composed of discrete processing blocks by sequentially arranging the processing blocks according to their respective indices. The indices assigned to the processing blocks by model scheduler 202 are stored in meta store 210 along with metadata indicating the model hub in which the processing blocks are pushed to. The indices and additional metadata may provide a snapshot of machine-implementable instructions to model scheduler 202 as to how to assemble the machine learning model by sequencing the ordering of the processing blocks. The indices may correspond to the file system used by the client to format the complete machine learning model, such as with the above example file format /path/to/model1/layer1,/path/to/model1/layer2, . . . , /path/to/model1/layern. The machine-implementable instructions enable the assembly of the machine learning model from the individual processing blocks according to the same format and/or follow the original directory structure used to generate the indices. This allows the machine learning model to be provided to a client with a same architecture/directory structure as the machine learning model may have originally existed on the client or another (e.g., different) client. Thus, arranged in accordance with their respective indices, the processing blocks form the complete machine learning model.

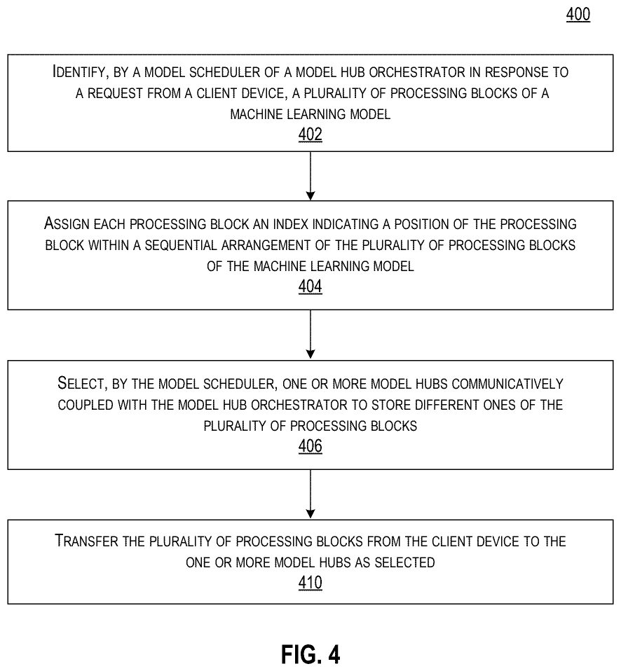

FIG. 4 illustrates an example method 400 of operation of MHO framework 200 of FIGS. 2 and 3. Referring to FIGS. 2, 3, and 4 collectively, in block 402, model scheduler 202 of MHO framework 200 identifies a processing block of a machine learning model in response to a client request. The processing block is identifiable by an index indicating a position of the processing block within a sequential arrangement of processing blocks of the machine learning model.

In block 404, model scheduler 202 associates the processing block identified with at least one of model hubs 208a-208n. The plurality of model hubs 208a-208n communicatively couple with MHO framework 200. The association of the identified processing block with one more model hubs 208a-208n is based on metadata. The metadata may be persisted in meta store 210. In block 406, the processing block is transferred between at least one of the plurality of model hubs 208a-208n and a client identified by the client request. In some arrangements, model scheduler 202 is capable of replicating the processing block(s) and storing the processing blocks and replicas thereof in separate model hubs to safeguard against loss due to failure of one of the hubs, as described in greater detail below. The transfer of the processing block between one of clients 212a-212k and one or more model hubs 208a-208n is performed in response to the client request. The transfer may be to push the processing block along with other processing blocks of a machine learning model from the client to one or more model hubs 208a-208n or to pull the processing blocks from the one or more model hubs to the client. Both types of transfer are described in greater detail below.

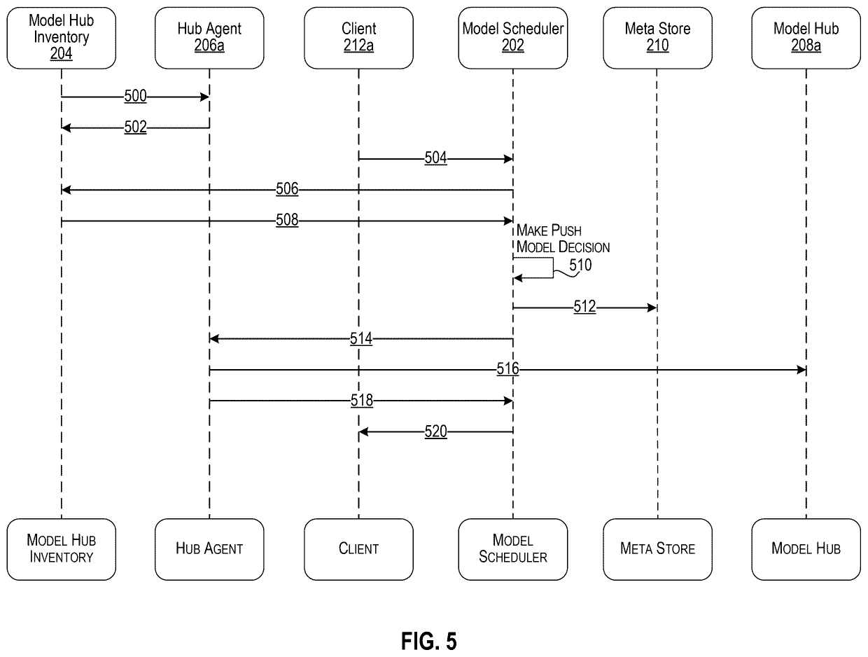

FIG. 5 is a signal diagram illustrating certain operations performed by MHO framework 200 in pushing one or more processing blocks to one or more model hubs. Signal 500 from model hub inventory 204 to hub agent 206a requests model hub metrics for model hub 208a. The model hub metrics are returned with signal 502. Though not explicitly shown, model hub inventory 204 likewise acquires model hub metrics for each of the other model hubs 208b-208n from their respective hub agents 206b-206n. The model hub metrics may be acquired in response to signal 504 from client 212a to model scheduler 202 requesting to push a machine learning model from the client to a model hub or the metrics may have been previously persisted to model hub inventory 204. In either event, model scheduler 202 with signal 506 queries model hub inventory 204, which with signal 508 returns the model hub metrics to the model scheduler. Model scheduler 202 makes decision 510, deciding based on the size of each of the model's processing blocks and metrics of model hubs 208a-208n which model hub(s) to push the processing blocks to after having uploaded the processing blocks from client 212a. Model scheduler 202 with signal 512 conveys to meta store 210 an index for each processing block and corresponding metadata linking each index to the model hub in which the processing block has been persisted. Signal 514 from model scheduler 202 to hub agent 206a directs the hub agent to convey one or more of the processing blocks for storage in model hub 208a. Signal 516 from hub agent 206a conveys one or more processing blocks to model hub 208a in accordance with model scheduler 202's directive and is followed by signal 518 from the model hub to the model scheduler confirming the push. When each of the processing blocks of the machine learning model have been persisted to one or more model hubs, model scheduler 202 notifies client 212a via signal 520 that the push is complete.

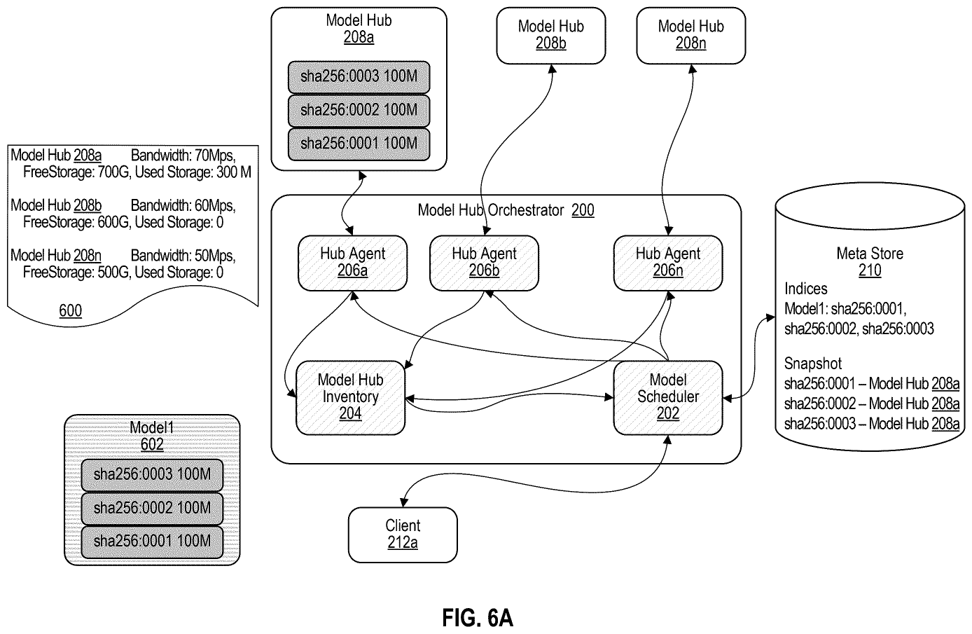

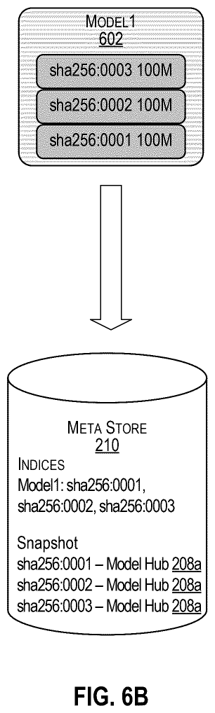

FIGS. 6A and 6B illustrate the role of user-specified policies in MHO framework 200's performing a push. Policies may be stored in MHO framework 200 and implemented in accordance with each user request. Model scheduler 202 implements the specified policy in accordance with the client request. The policies, in various embodiments, may dictate whether MHO framework 200 is to replicate the processing blocks and push the replicas to separate model hubs. In other embodiments, a policy may dictate whether the processing blocks should be persisted in a single model hub (assuming available space) or in multiple model hubs. Illustratively, in FIG. 6A model hub metrics 600 indicate the respective bandwidths, free storage, and used storage for model hubs 208a, 208b, and 208n. Machine learning model1 illustratively comprises three processing blocks 602, each comprising 100 megabytes (100 M). Model scheduler 202, in certain embodiments, may identify the distinct processing blocks from files to which the blocks are allocated to by client 212a. FIG. 6A illustrates MHO framework 200's response to a user request to push machine learning model1 under the user-specified policies of pushing the processing blocks to a single hub (if available) and without replication. Model scheduler 202 in accordance with the policies pushes each of the processing blocks to the single model hub, model hub 208a, via associated hub agent 206a. In FIG. 6B, model scheduler 202 stores indices for each processing block in meta store 210 along with a snapshot indicating the model hub in which the processing blocks are pushed to. The snapshot provides machine-implementable instructions to model scheduler 202 as to how to assemble the machine learning model by sequencing the ordering of the processing blocks.

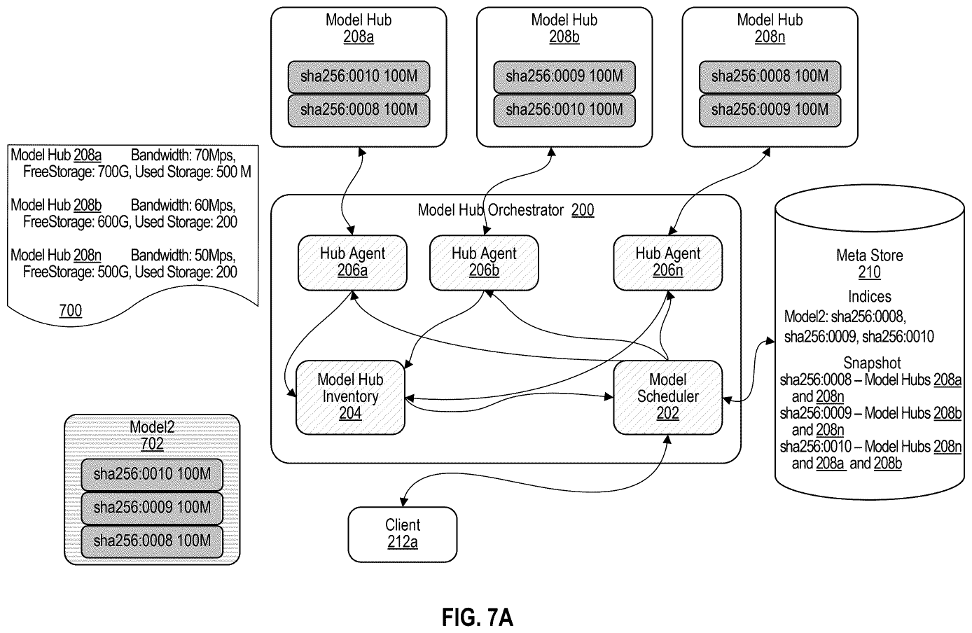

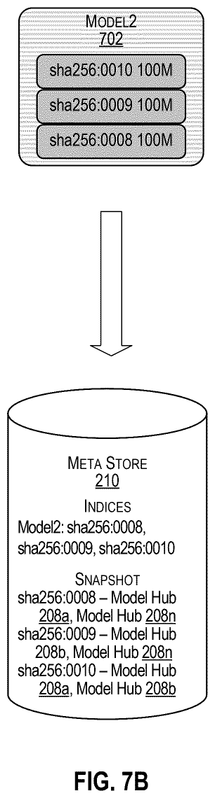

FIGS. 7A and 7B illustrate a different set of user policies in MHO framework 200's performing a push. FIG. 7A illustrates MHO framework 200's response to a user request to push machine learning model2 comprising three processing blocks 702 under the user-specified policies of pushing the processing blocks to multiple hubs and replicating each of the processing blocks. Hub metrics 700 indicate the respective bandwidths, free storage, and used storage for model hubs 208a, 208b, and 208n. Machine learning model comprises three distinct processing blocks 702. In accordance with the user-specified policies, MHO framework 200 replicates each of processing blocks 702, and model scheduler 202 selects model hubs for storing each replica in a separate model hub. Model scheduler 202 pushes two processing blocks (indexed as 0010 and 0008) to model hub 208a, two processing blocks (indexed as 0009 and 0010) to model hub 208b, and two processing blocks (indexed as 0008 and 009) to model hub 208 n. Processing blocks with the same index are identical copies for redundant storage of the replicated processing blocks. In FIG. 7B, model scheduler 202 stores indices for each processing block and replica in meta store 210 along with a snapshot indicating the model hub in which the processing blocks (including replicas) are pushed to. The snapshot provides a kind of blueprint for sequentially assembling the processing blocks according to the respective indices of each in response to a request to pull machine learning model2.

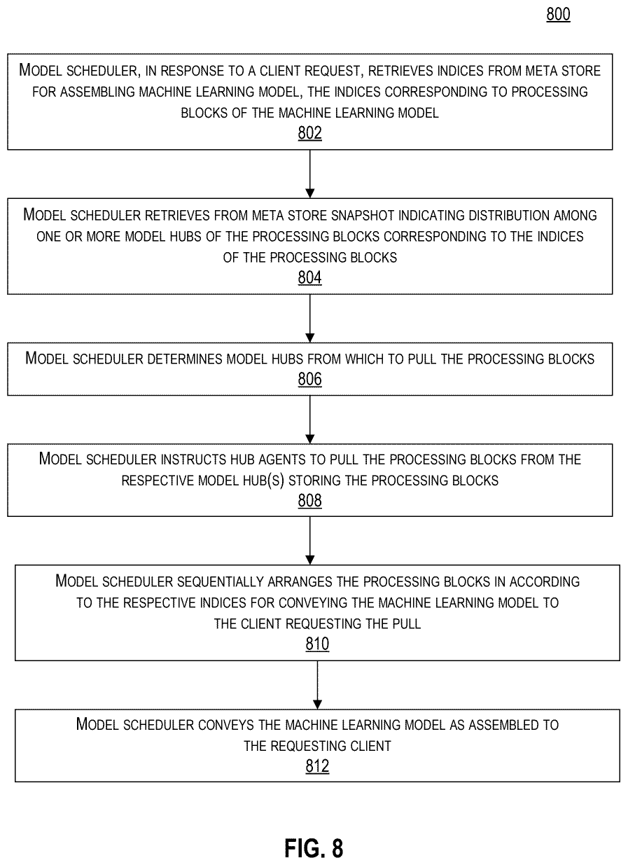

FIG. 8 illustrates an example method 800 of operation of MHO framework 200 of FIGS. 2 and 3. Referring now to FIGS. 2, 3, and 8 collectively, in block 802, model scheduler 202 retrieves indices from meta store 210 for assembling a machine learning model in response to a user request to pull the machine learning model, the indices specifying, or corresponding to, processing blocks of the machine learning model. In block 804, model scheduler 202 retrieves from meta store 210 the snapshot indicating distribution among one or more model hubs 208a-208n of the processing blocks corresponding to the indices of the processing blocks. In block 806, model scheduler 202 determines the model hubs from which to pull the processing blocks. In block 808, model scheduler instructs hub agents to pull the processing blocks from the respective model hub(s) storing the processing blocks. In block 810, model scheduler 202 sequentially arranges the processing blocks according to the respective indices for conveying the complete machine learning model to the client requesting the pull. In block 812, model scheduler conveys the machine learning model as assembled to the requesting client.

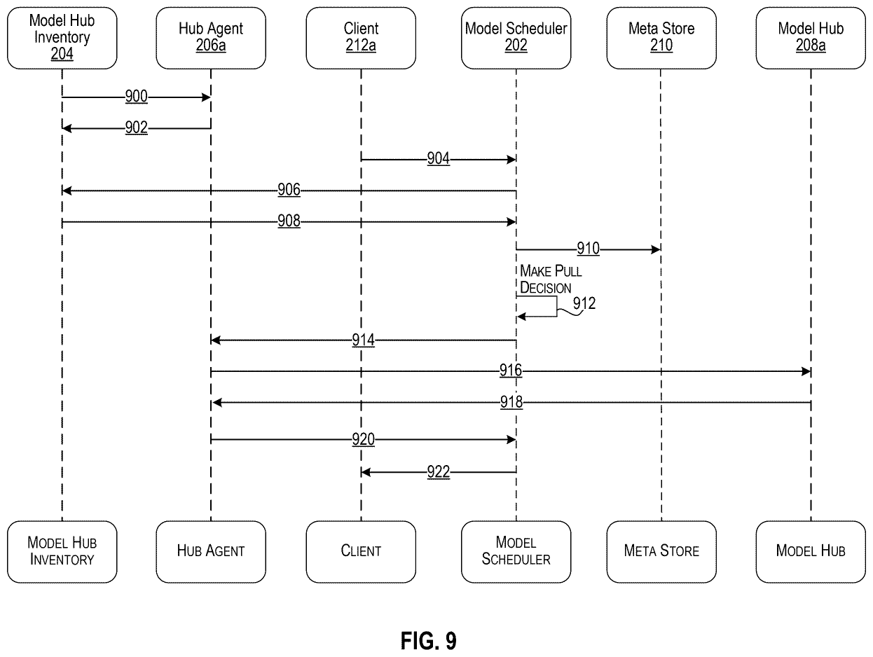

FIG. 9 is a signal diagram illustrating certain operations performed by MHO framework 200 in pulling one or more processing blocks from one or more model hubs. Signal 900 from model hub inventory 202 to hub agent 206a requests model hub metrics for model hub 208a. The model hub metrics are returned with signal 902. Though not explicitly shown, model hub inventory 202 may likewise acquire model hub metrics for each of the other model hubs 208b-208n from their respective hub agents 206b-206n. The hub metrics may include the respective bandwidths available for each model hub. If replicated processing blocks are stored in multiple model hubs, model scheduler 202 may use the hub metrics to select which model hubs to pull the processing blocks from to avoid network congestion, the selecting based on the respective bandwidths of each model hub (e.g., to maximize bandwidth and transfer rates). In one or more embodiments, the decision as to which model hub to pull processing blocks may be made dynamically and/or in real time such that a processing block may be obtained from a first model hub, but as bandwidth to the model hub deteriorates, a decision is made to obtain any further processing blocks from a different model hub. In one or more other embodiments, it should be appreciated that bandwidth also may be used as a factor in deciding which model hub(s) is/are to be used to store processing blocks. That is, model hubs with higher bandwidth connections may be selected for storing processing blocks over other model hubs with lower bandwidth connections. As previously noted with respect to a push request, the model hub metrics may have been previously persisted to model hub inventory 202 or may be acquired in response to signal 904 from client 212a to model scheduler 202 requesting to pull a machine learning model. In either event, again as with the push request, model scheduler 202 with signal 906 queries model hub inventory 204, which with signal 908 returns the model hub metrics to the model scheduler. With the pull request, model scheduler 202 must also ascertain in which model hubs processing blocks of the machine learning model requested are stored. Accordingly, with signal 910 model scheduler 202 queries meta store 210. With decision 912, model scheduler 202 determines the location of the processing blocks and conveys signal 914 to hub agent 206a and other hub agents corresponding to model hubs in which the processing blocks of the requested model are stored. Hub agent 206a conveys signal 916 to model hub 208a, which with signal 918 responds by sending processing block(s) to the hub agent. Similar action occurs with respect to any other hub agent and corresponding model hub storing relevant processing blocks. Signal 920 from hub agent 206a to model scheduler 202 confirms the action (e.g., receipt of the processing blocks) with respect to model hub 208a. Model scheduler 202 confirms completion of the request with signal 922 to client 212a and conveys to the client the machine learning model assembled by the model scheduler by sequentially ordering the multiple processing blocks forming the model.

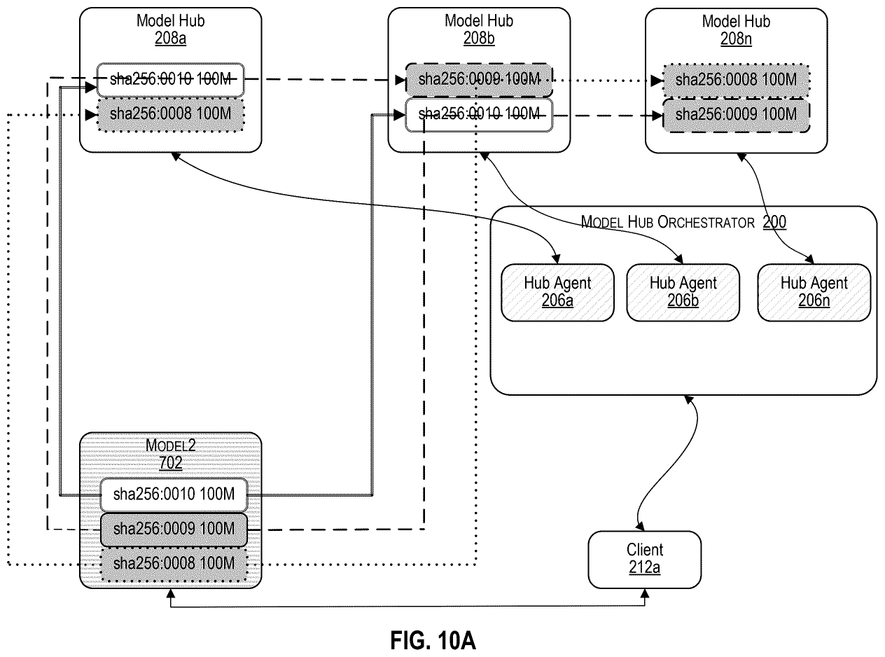

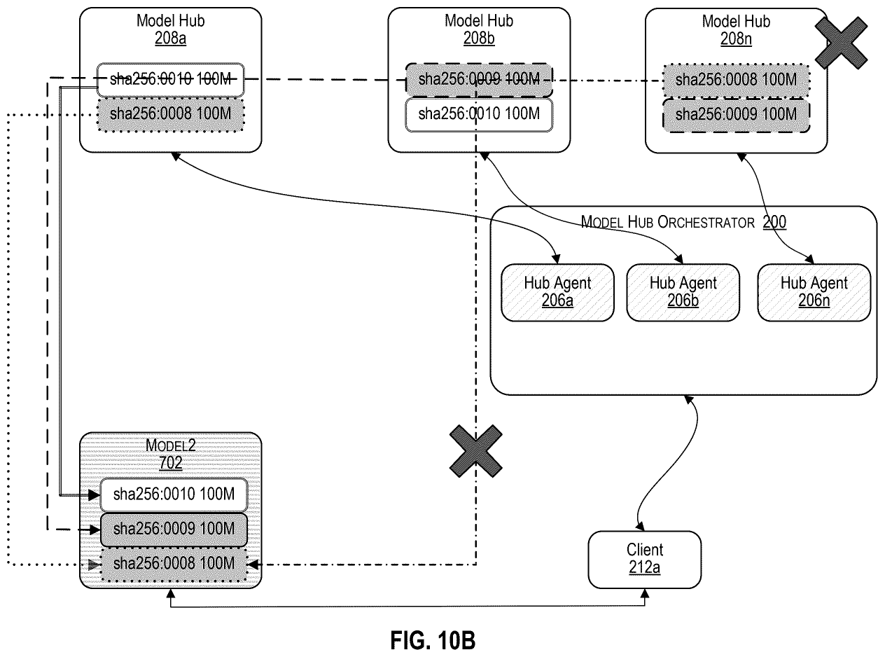

FIGS. 10A and 10B illustrate certain operations performed by MHO framework 200 of FIG. 2 in pushing multiple processing blocks of a machine learning model to multiple model hubs and subsequently pulling the processing blocks from the model hubs. FIG. 10A illustrates MHO framework 200's pushing machine learning model2 comprising processing blocks 702 under the user-specified policies described in the context of FIG. 7A. The user-specified policies are that processing blocks 702 be pushed to multiple hubs and that replicas of each processing block be stored in separate model hubs, as described in FIG. 7A. Implementing the user-specified policies, model scheduler 202 utilizes hub agents 206a, 206b, and 206n to push two processing blocks (indexed as 0010 and 0008) to model hub 208a, two processing blocks (indexed as 0009 and 0010) to model hub 208b, and two processing blocks (indexed as 0008 and 009) to model hub 208 n.

FIG. 10B illustrates MHO framework 200's pulling machine learning model2 comprising processing blocks 702 when one model hub, model hub 208n, has failed. Two of the processing blocks (indexed as 0008 and 009) are thus not available from model hub 208 n. Replicas of the two processing blocks are available from model hubs 208a and 208b, however. Model scheduler 202 identifies the other two hubs from the snapshot in meta store 210 and pulls two processing blocks (indexed as 0010 and 0008) from model hub 208a and one processing block (indexed as 0009) from model hub 208b. Utilizing the replication of processing blocks 702, MHO framework 200 is able to assemble the complete machine learning model by sequentially arranging the total complement of processing blocks despite the failure of model hub 208n.

The terminology used herein is for the purpose of describing particular embodiments only and is not intended to be limiting. Notwithstanding, several definitions that apply throughout this document now will be presented.

As defined herein, the singular forms “a,” “an,” and “the” are intended to include the plural forms as well, unless the context clearly indicates otherwise.

As defined herein, the terms “at least one,” “one or more,” and “and/or,” are open-ended expressions that are both conjunctive and disjunctive in operation unless explicitly stated otherwise. For example, each of the expressions “at least one of A, B, and C,” “at least one of A, B, or C,” “one or more of A, B, and C,” “one or more of A, B, or C,” and “A, B, and/or C” means A alone, B alone, C alone, A and B together, A and C together, B and C together, or A, B and C together.

As defined herein, the term “automatically” means without user intervention.

As defined herein, the term “if” means “when” or “upon” or “in response to” or “responsive to,” depending upon the context. Thus, the phrase “if it is determined” or “if [a stated condition or event] is detected” may be construed to mean “upon determining” or “in response to determining” or “upon detecting [the stated condition or event]” or “in response to detecting [the stated condition or event]” or “responsive to detecting [the stated condition or event]” depending on the context.

As defined herein, the terms “one embodiment,” “an embodiment,” “one or more embodiments,” or similar language mean that a particular feature, structure, or characteristic described in connection with the embodiment is included in at least one embodiment described within this disclosure. Thus, appearances of the phrases “in one embodiment,” “in an embodiment,” “in one or more embodiments,” and similar language throughout this disclosure may, but do not necessarily, all refer to the same embodiment. The terms “embodiment” and “arrangement” are used interchangeably within this disclosure.

As defined herein, the term “processor” means at least one hardware circuit. The hardware circuit may be configured to carry out instructions contained in program code. The hardware circuit may be an integrated circuit. Examples of a processor include, but are not limited to, a central processing unit (CPU), an array processor, a vector processor, a digital signal processor (DSP), a field-programmable gate array (FPGA), a programmable logic array (PLA), an application specific integrated circuit (ASIC), programmable logic circuitry, and a controller.

As defined herein, the term “real-time” means a level of processing responsiveness that a user or system senses as sufficiently immediate for a particular process or determination to be made, or that enables the processor to keep up with some external process.

As defined herein, the term “responsive to” and similar language as described above, e.g., “if,” “when,” or “upon,” mean responding or reacting readily to an action or event. The response or reaction is performed automatically. Thus, if a second action is performed “responsive to” a first action, there is a causal relationship between an occurrence of the first action and an occurrence of the second action. The term “responsive to” indicates the causal relationship.

The term “substantially” means that the recited characteristic, parameter, or value need not be achieved exactly, but that deviations or variations, including for example, tolerances, measurement error, measurement accuracy limitations, and other factors known to those of skill in the art, may occur in amounts that do not preclude the effect the characteristic was intended to provide.

The terms first, second, etc. may be used herein to describe various elements. These elements should not be limited by these terms, as these terms are only used to distinguish one element from another unless stated otherwise or the context clearly indicates otherwise.

The corresponding structures, materials, acts, and equivalents of all means or step plus function elements that may be found in the claims below are intended to include any structure, material, or act for performing the function in combination with other claimed elements as specifically claimed.

The description of the embodiments provided herein is for purposes of illustration and is not intended to be exhaustive or limited to the form and examples disclosed. The terminology used herein was chosen to explain the principles of the inventive arrangements, the practical application or technical improvement over technologies found in the marketplace, and/or to enable others of ordinary skill in the art to understand the embodiments disclosed herein. Modifications and variations may be apparent to those of ordinary skill in the art without departing from the scope and spirit of the described inventive arrangements. Accordingly, reference should be made to the following claims, rather than to the foregoing disclosure, as indicating the scope of such features and implementations.

What is claimed is:

1. A computer-implemented method, comprising:
identifying, by a model scheduler of a model hub orchestrator in response to a request from a client device, a plurality of processing blocks of a machine learning model;
assigning each processing block an index indicating a position of the processing block within a sequential arrangement of the plurality of processing blocks of the machine learning model;
selecting, by the model scheduler, one or more model hubs communicatively coupled with the model hub orchestrator to store different ones of the plurality of processing blocks; and
transferring the plurality of processing blocks from the client device to the one or more model hubs as selected.

2. The computer-implemented method of claim 1, wherein the request specifies a policy, and wherein the transferring comprises pushing the plurality of processing blocks from the client to the one or more model hubs as selected based on the policy specified by the request.

3. The computer-implemented method of claim 2, wherein the policy specifies pushing the plurality of processing blocks to more than one of the plurality model hubs, and wherein the model scheduler determines which of the plurality of model hubs to push the plurality of processing blocks based on model hub metrics collected by a plurality of hub agents and persisted in a model hub inventory.

4. The computer-implemented method of claim 3, further comprising:
replicating, by the model scheduler, at least one pair of processing blocks based on the policy; and
pushing, by the model scheduler, each of the pair of replicated processing blocks to separate model hubs.

5. The computer-implemented method of claim 1, further comprising:
pulling the plurality of processing blocks from the one or more model hubs.

6. The computer-implemented method of claim 5, wherein the plurality of processing blocks are stored in a plurality of model hubs with redundancy, and wherein the pulling comprises retrieving the plurality of processing blocks from a subset of the plurality of model hubs storing the plurality of processing blocks.

7. The computer-implemented method of claim 6, wherein the plurality of processing blocks includes at least one pair of replicated processing blocks, and wherein one of the pair of replicated processing blocks is pulled from one of the plurality of model hubs in response to the model scheduler determining that a different one of the plurality of model hubs in which the other of replicated processing blocks is stored is currently offline.

8. A computer system, comprising:
a processor set;
one or more computer-readable storage media; and
program instructions stored on the one or more computer-readable storage media to cause the processor set to perform operations comprising:
identifying, by a model scheduler of a model hub orchestrator in response to a request from a client device, a plurality of processing blocks of a machine learning model;
assigning each processing block an index indicating a position of the processing block within a sequential arrangement of the plurality of processing blocks of the machine learning model;
selecting, by the model scheduler, one or more model hubs communicatively coupled with the model hub orchestrator to store different ones of the plurality of processing blocks; and
transferring the plurality of processing blocks from the client device to the one or more model hubs as selected.

9. The computer system of claim 8, wherein the request specifies a policy, and wherein the transferring comprises pushing the plurality of processing blocks from the client to the one or more model hubs as selected based on the policy specified by the request.

10. The computer system of claim 9, wherein the policy specifies pushing the plurality of processing blocks to more than one of the plurality model hubs, and wherein the model scheduler determines which of the plurality of model hubs to push the plurality of processing blocks based on model hub metrics collected by a plurality of hub agents and persisted in a model hub inventory.

11. The computer system of claim 10, wherein the operations further comprise:
replicating, by the model scheduler, at least one pair of processing blocks based on the policy; and
pushing, by the model scheduler, each of the pair of replicated processing blocks to separate model hubs.

12. The computer system of claim 8, wherein the operations further comprise:
pulling the plurality of processing blocks from the one or more model hubs.

13. The computer system of claim 12, wherein the plurality of processing blocks are stored in a plurality of model hubs with redundancy, and wherein the pulling comprises retrieving the plurality of processing blocks from a subset of the plurality of model hubs storing the plurality of processing blocks.

14. A computer program product, comprising:
one or more computer-readable storage media; and
program instructions stored on the one or more computer-readable storage media to perform operations comprising:
identifying, by a model scheduler of a model hub orchestrator in response to a request from a client device, a plurality of processing blocks of a machine learning model;
assigning each processing block an index indicating a position of the processing block within a sequential arrangement of the plurality of processing blocks of the machine learning model;
selecting, by the model scheduler, one or more model hubs communicatively coupled with the model hub orchestrator to store different ones of the plurality of processing blocks; and
transferring the plurality of processing blocks from the client device to the one or more model hubs as selected.

15. The computer program product of claim 14, wherein the processing block is one of a plurality of processing blocks, wherein the client request specifies a policy, and wherein the transferring comprises pushing the plurality of processing blocks from the client to the at least one of the plurality of model hubs according to the policy specified by the client request.

16. The computer program product of claim 15, wherein the policy specifies pushing the plurality of processing blocks to more than one of the plurality model hubs, and wherein the model scheduler determines which of the plurality of model hubs to push the plurality of processing blocks based on model hub metrics collected by a plurality of hub agents and persisted in a model hub inventory.

17. The computer program product of claim 16, wherein the operations further comprise:
replicating, by the model scheduler, at least one pair of processing blocks based on the policy; and
pushing, by the model scheduler, each of the pair of replicated processing blocks to separate model hubs.

18. The computer program product of claim 14, wherein the operations further comprise:
pulling the plurality of processing blocks from the one or more model hubs.

19. The computer program product of claim 18, wherein the plurality of processing blocks are stored in a plurality of model hubs with redundancy, and wherein the pulling comprises retrieving the plurality of processing blocks from a subset of the plurality of model hubs storing the plurality of processing blocks.

20. The computer program product of claim 19, wherein the plurality of processing blocks includes at least one pair of replicated processing blocks, and wherein one of the pair of replicated processing blocks is pulled from one of the plurality of model hubs in response to the model scheduler determining that a different one of the plurality of model hubs in which the other of replicated processing blocks is stored is currently offline.
